(19) United States
(12) Patent Application Publication
(10) Pub. No.: US 2024/0393490 A1
(43) Pub. Date: Nov. 28, 2024

(54) WELL SENSOR SYSTEMS FOR DOWNHOLE SENSING

(71) Applicant: THE REGENTS OF THE UNIVERSITY OF CALIFORNIA, Oakland, CA (US)

(72) Inventors: Patrick MERCIER, La Jolla, CA (US); Tatsuya YAGUCHI, Tokyo (JP)

(21) Appl. No.: 18/695,475

(22) PCT Filed: Oct. 19, 2022
(86) PCT No.: PCT/US2022/047137

§ 371 Date: Mar. 26, 2024

Related U.S. Application Data
(60) Provisional application No. 63/257,712, filed on Oct. 20, 2021.

(51) Int. Cl. G01V 1/50; E21B 47/017; G01V 1/04

(52) U.S. Cl. CPC G01V 1/50; E21B 47/017; G01V 1/04; G01V 2210/74

(57) ABSTRACT

A well imaging sensor device includes a sealed housing transparent to ultrasound waves and resistant to downhole pressures. The housing is configured to attach to a downhole equipment piece while allowing the downhole equipment piece to perform its intended function. Components in the housing include a battery, a motor, an ultrasound generator with an angled reflective surface, an ultrasound sensor spaced apart from the ultrasound generator, and ultrasonic amplification medium between the ultrasound generator and the ultrasound sensor. The ultrasound generator is mounted on a mount that rotates in response to the motor and extends through a seal that seals the ultrasound amplification medium away from the battery and the motor.

### PRIORITY CLAIM AND REFERENCE TO RELATED APPLICATION

The application claims priority under 35 U.S.C. § 119 and all applicable statutes and treaties from prior U.S. provisional application Ser. No. 63/257,712, which was filed Oct. 20, 2021.

### FIELD

Fields of the invention include well sensor, well boring, oil and gas exploration and hydraulic fracturing.

### BACKGROUND

Hydraulic fracturing produces fractures in rock formations that stimulate the flow of natural gas or oil, increasing the volumes that can be recovered. In this process, frac plugs enable zonal isolation, e.g., so a lower wellbore zone can be temporarily isolated from a treatment conducted on an upper zone. Frac plugs serve as check valves to achieve wellbore zonal isolation in multistage stimulation treatments. A lower zone is isolated during stimulation, while flow is allowed from below to aid in well cleanup.

Some frac plugs are designed to degrade easily in water-based wellbore fluid, formation fluid, or production fluid after a completion of a process requiring zonal isolation. This degradation can eliminate the cost and time of a milling out process to remove the frac plug. However, frac plugs sometimes fail to degrade, which can interfere with well production. Other types of frac plugs are designed to be drilled out after a zonal isolation operation. Debris or incomplete removal can also interfere with well production after a zonal isolation operation. Occasionally, either type of frac plug can be improperly or incompletely set such as due to damage or preset during installation of the frac plug. An improper set can allow fluid being used in an upper zone, such as in wellbore cleaning operation, to travel to lower zones.

Another problem concerns distortion of the pipe, which can prevent it from reaching the target zone. Though these problems are common in a wellbore, it is difficult to detect the cause of the problems because the frac plugs are installed in deep underground.

Inspection is required to determine the cause of such problems. Conventional methods require separate deployment of imaging equipment into a well on a separate tool. Conventional devices have several hundreds of ultrasound transducers to emit ultrasound in all directions. This is one reason the diameter of the device increases and cannot be inserted in wellbore with other down hole tools, such as a frac plug. Inspecting the casing wall therefore requires a stop of production and removal of all tools from the wellbore. It is also very difficult to supply power for such an imaging system. Inspection cannot occur during well boring operations since other tools must be removed from a well before the inspection device can be deployed. This makes it difficult and expensive to provide information about a well during completion operations.

Schmidt et al., U.S. Pat. No. 5,640,371 describes an acoustic sonde for down hole well logging operations. The apparatus acoustically logs earth formations surrounding a bore hole containing a fluid, with a down hole logging instrument adapted for longitudinal movement through the bore hole. An acoustic transducer assembly is provided within the logging instrument and incorporates a large cylindrical array of piezo-electric elements with the array being fixed within the housing structure. This apparatus is separate from the bottom (down) hole assembly and therefore has the drawbacks mentioned above.

CN Patent Publication 101363314 describes an ultrasonic phased array sleeve well circle and front spy integral inspection method used for measuring an oil well underground sleeve which is realized by a columnar phased array well circle scanning ultrasonic transducer. This publication describes that 96-128 bars of ultrasound transducer are required. The bulk introduced by so many transducers prevents it from being used with the tip of borehole assembly because this device is larger than the inner diameter of a typical frac plug.

CN Patent Publication 200985790 describes a columnar phase array well circumference scanning ultrasonic transducer, which is composed of a plurality of transducer units. The transducer units are arranged in a ring shape and on a columnar basal body, and free from any disturbance or influence of each other. As with the publication in the previous paragraph, the many transducer units prevents this device from being used with the tip of borehole assembly because this device is larger than the inner diameter of frac plug.

### SUMMARY OF THE INVENTION

A preferred embodiment provides a well imaging sensor device that includes a sealed housing transparent to ultrasound waves and resistant to downhole pressures. The housing is configured to attach to a downhole equipment piece while allowing the downhole equipment piece to perform its intended function. Components in the housing include a battery, a motor, an ultrasound generator with an angled reflective surface, an ultrasound sensor spaced apart from the ultrasound generator, and ultrasonic amplification medium between the ultrasound generator and the ultrasound sensor. The ultrasound generator is mounted on a mount that rotates in response to the motor and extends through a seal that seals the ultrasound amplification medium away from the battery and the motor.

### BRIEF DESCRIPTION OF THE DRAWINGS

FIGS. 1A-1C show a preferred well sensor system and an image generated by the system;

FIGS. 2A and 2B shows a preferred well sensor assembly formed as an adapter to connect to a bottom hole assembly;

FIGS. 3A and 3B show the structure and exemplary dimensions for an adapter housing with attachment features of the preferred adapter of FIGS. 2A and 2B;

FIGS. 4A-4E illustrates details of a preferred imaging sensor and well sensor assembly; and

FIG. 5A-5F show a circuit for a preferred well sensor assembly (FIG. 5A) and a method for imaging (FIGS. 5B-5F).

### DETAILED DESCRIPTION OF THE PREFERRED EMBODIMENTS

A preferred embodiment well sensor system provides high resolution imaging of a well during completion operations. In addition to imaging, the system can also gather data for other parameters, such as temperature and pressure in wellbore at the same time. A system of the invention can be integrated with other well tools, such as a bottom hole assembly, which advantageously allows operators to gather information without stopping completion operations.

Preferred embodiments of the invention will now be discussed with respect to prototype devices and drawings. Broader aspects of the invention will be understood by artisans in view of the general knowledge in the art and the description of the experiments that follows.

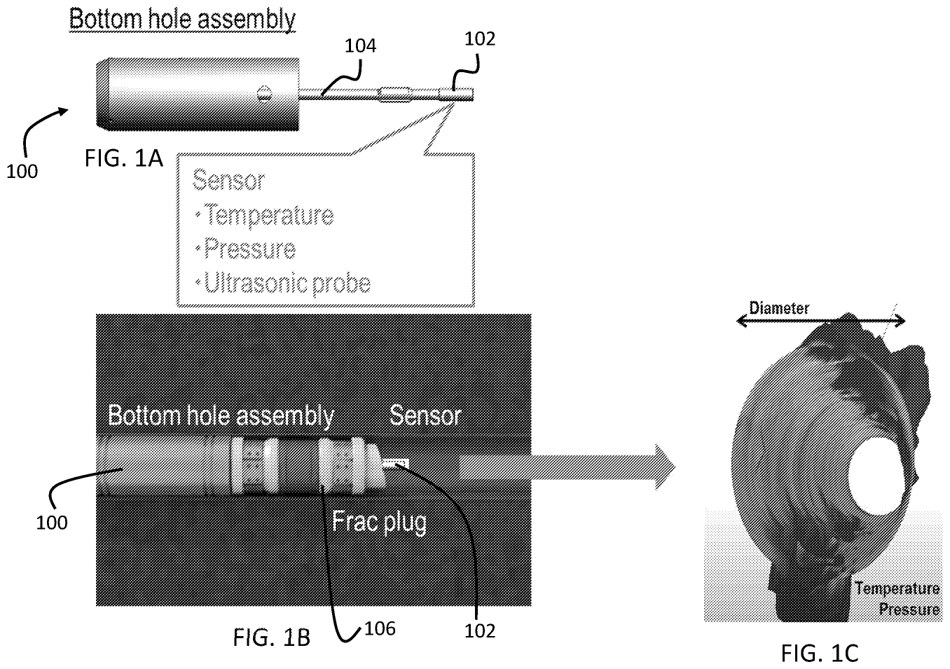

FIGS. 1A and 1B show a preferred bottom hole assembly 100 including a well sensor module 102 of the invention. The bottom hole assembly 100 includes a central rod 104 on which the imaging system module 102 is mounted. The well sensor module 102 preferably includes temperature, pressure and ultrasonic probe sensors. The central rod 104 is part of an otherwise conventional bottom hole assembly and is typically used as a connector between a setting tool and a frac plug 106.

In the bottom hole assembly 100, the well sensor module 102 is attached to a tip of the inner tension rod 104, which can be extended through a frac plug 106, as shown in FIG. 1B. The well sensor module 102 can measure the distance between itself and the casing wall, and other downhole parameters. The well sensor module 102 includes memory, and sensor data from measurements are stored in memory. When the well sensor module 102 returns to ground surface with the bottom hole assembly 100, the sensor data stored in the inspection module 102 can be accessed and analyzed by software. Preferred inspection modules include 3D imaging sensors, and example 3D image is shown as output in FIG. 1C.

The inspection module 102 can be in the form of an adapter kit that can be connected to the distal end of the central rod 104 of a conventional setting tool. The proximal end of the central rod 104 of the adapter kit is connected to above ground equipment via a wireline. Unfortunately, it is impractical or perhaps impossible to electrically connect the inspection module 102 to an above ground setting while it is located down the well. The inspection module 102 therefore includes a local power source, e.g., batteries. The data cannot be monitored in real time by equipment on the ground without connection to above ground equipment, so data are saved in memory for later reading and analysis.

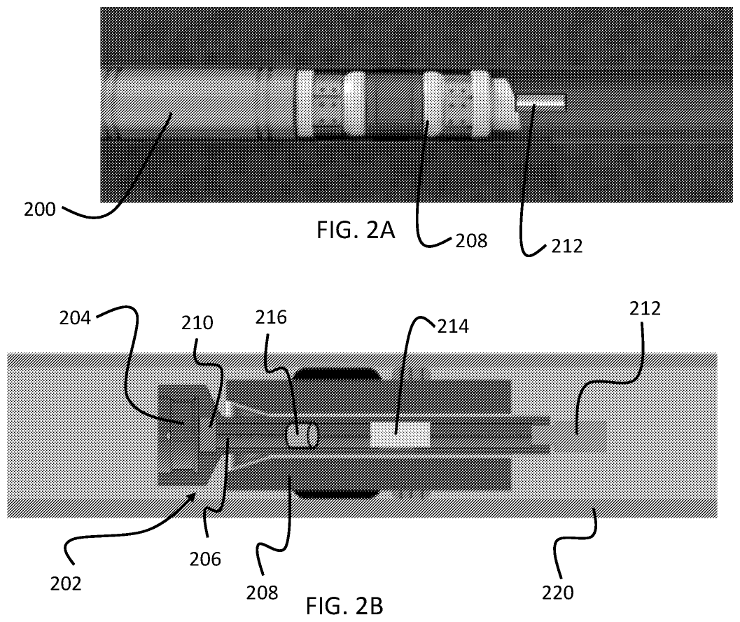

FIGS. 2A and 2B show a preferred well sensor assembly 202 formed as an adapter 204 to connect to a bottom hole assembly 200. The adapter 204 includes a central tubular housing 206 that is shaped and dimensioned to extend through the central lumen of a frac plug 208. Sensors are housed by the adapter 204 and can be inserted into the wellbore when the frac plug is set. A preferred adapter 204 includes a proximal pressure sensor 210 and a distal imaging sensor 212 at an exposed end of the central tubular housing 206, which housing is sealed at both its proximal end by the pressure sensor 210 that can be in a sealed cap and at its distal end by the imaging sensor 212 that also forms a cap/seal. A microcontroller 214 housed or packaged with memory and a temperature sensor is centrally located and powered by a battery 216, which also powers the pressure sensor 210 and imaging sensor 212 through a wired connection to each. The microcontroller 214 gathers and saves sensor data, for example, about the shape of a casing wall 220 in which the frac plug 208 is installed or is being installed, images of the environment, temperature measurements and pressure measurements over time. After the adapter 204 returns to the ground surface, the data are output for analysis to a computer or via a network. The casing wall 220 can be, for example, a pipe that transports oil and gas to the ground after stimulating a well.

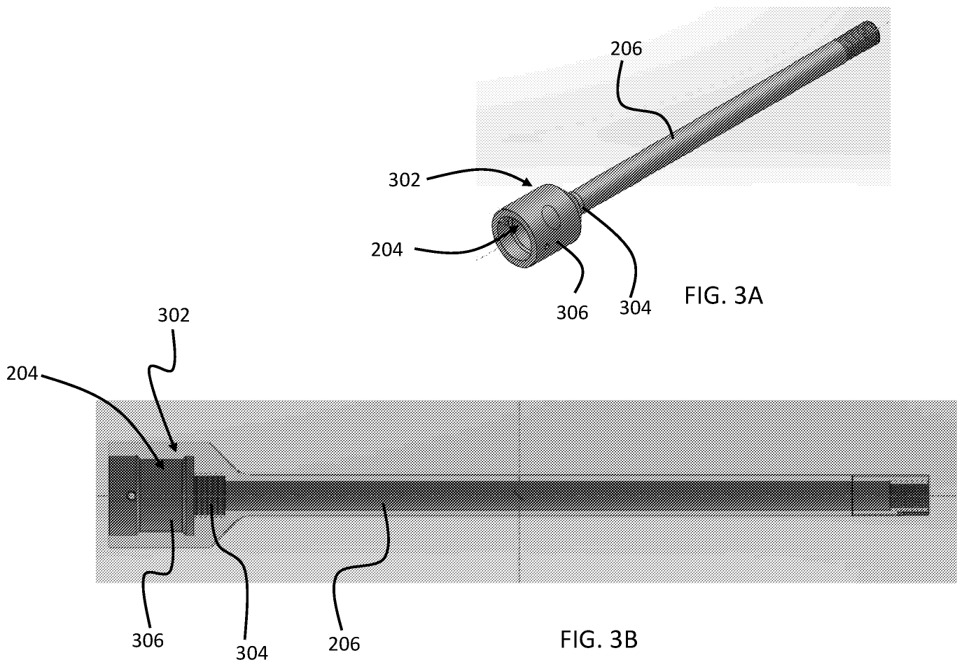

FIGS. 3A and 3B shows the structure for an adapter housing 204 with attachment features of the preferred adapter of FIGS. 2A and 2B. A fitting 302 at its proximal end. The fitting 302 includes a smaller attachment portion 304, for example threads, and is dimensioned and configured to attach to internal lumen of the pressure sensor 210, which as mentioned above can be part of a sealed proximal cap of the central tubular housing 206. The fitting 302 also includes a larger attachment portion 306, for example threads that is dimensioned and configured to attach to a setting tool. A distal end of the housing 204 includes an attachment structure 308, e.g., threads, configured to attach to the imaging sensor 212. The adapter housing 204 can be made from a conventional down well material, i.e., a metal or alloy, such as steel. It needs to endure the high pressure (at most 15,000 psi). The adapter housing also seals when connected with the pressure sensor to protect the controller 214 from high pressure and water.

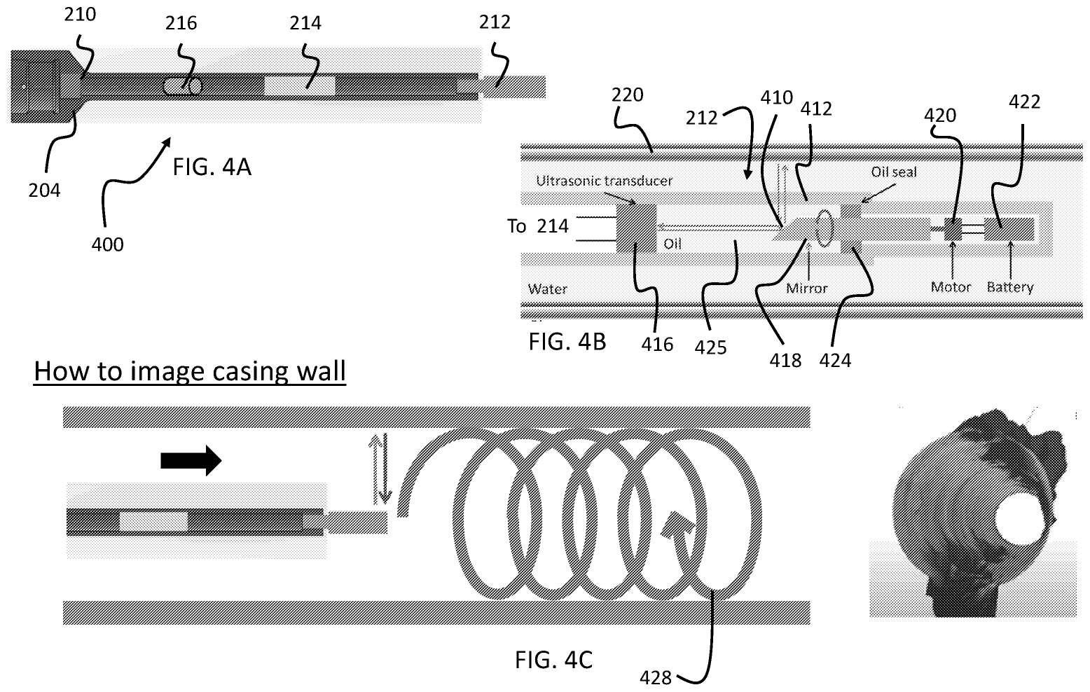

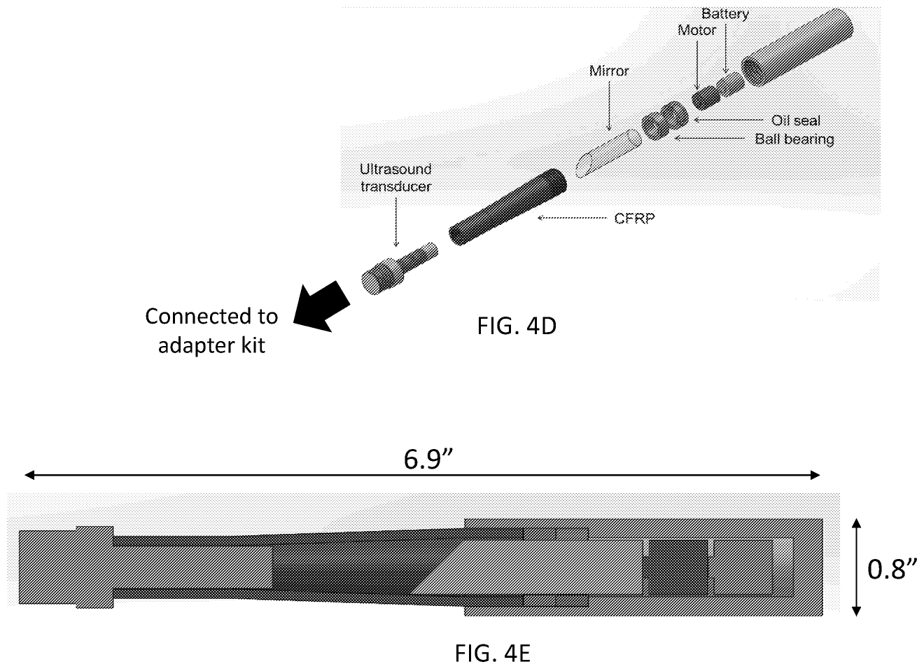

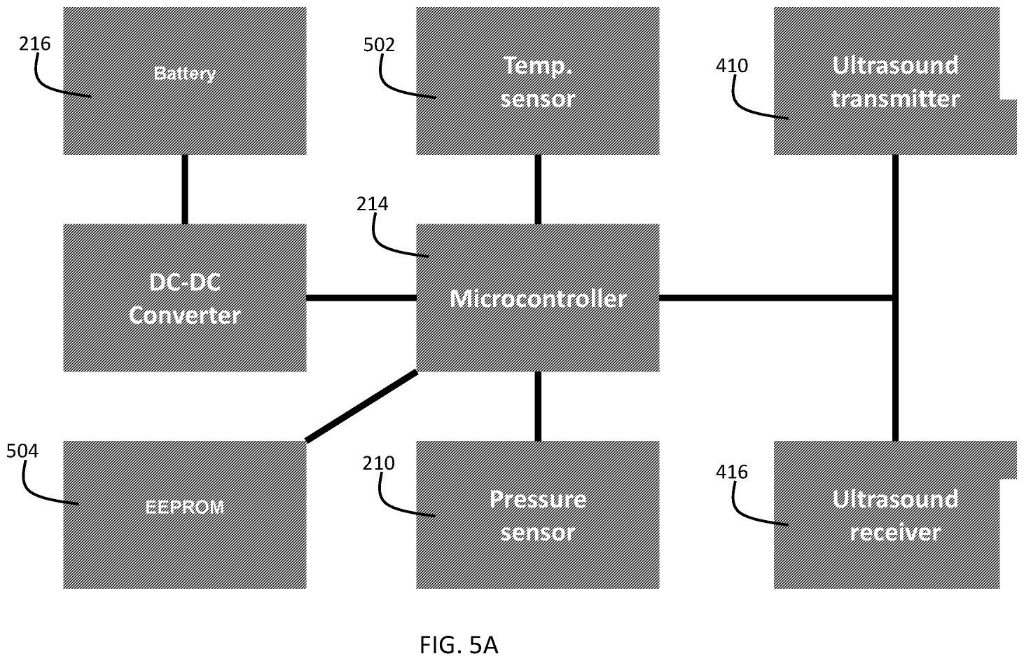

FIGS. 4A-4E illustrates details of a preferred imaging sensor and well sensor assembly 400, with exemplary dimensions and movements for a preferred imaging method in FIG. 4C. Like components are labeled with reference numbers from FIGS. 2A and 2B. Within the adapter housing is an ultrasonic sensor that forms a seal. Details of the preferred imaging sensor 212 are shown in FIGS. 4B, 4D and 4E. The imaging sensor 212 includes an ultrasonic generator 410 terminating in an angled emitter/wavelength selective mirror that serves to emit signals toward a housing wall 412 of the imaging sensor 212 and to reflect signals back toward an ultrasonic transducer 416, which is sealed to the housing wall 412 and connected to the microcontroller 214. The housing wall 412 is of a material that is substantially transparent to ultrasonic waves, i.e., it can transmit waves to and from the casing wall 202. The generator 410 is mounted on mount 418 that can be rotated by a motor 420 powered by a battery 422. The mount 418 extends through a seal 424, which allows oil or another ultrasonic amplification medium 425 to be contained between the seal 424 and the ultrasonic transducer 416, while isolating the motor 420 and the battery 422 from the oil. The motor 420 can include an encoder to measure rotation speed, which allows accurate adjustments to achieve desired rotation speeds for imaging. With control of the motor 420 by the microcontroller 214, it has been demonstrated that a well sensor of the invention can measure the distance to the casing pipe for every 1 degree rotation of the motor. Also, it can monitor the rotation speed of the motor using the encoder so that it can measure distance at the same sampling rate even if the rotation speed varies away from an intended speed.

The combination of the angle of emissions and the rotation can create the acoustic pattern 428 shown in FIG. 4C. The ultrasonic generator 410 with mirror is angled to direct ultrasonic waves perpendicular to the casing wall 208, e.g., preferably at 45 degrees. The mirror is made from material whose acoustic impedance is high, such as metal. A preferred material for the housing 412 is carbon fiber reinforced polymer (CRFP), which readily passes ultrasound and can also protect the imaging components from high pressure. The CFRP satisfies both requirements. Alternative materials for the housing 412 include super engineered plastics, such as PEEK and PPS.

In general, the housing 412 needs to be made from engineered plastic-based materials that are strong enough to withstand pressure. Applying metal-based materials improves reliability against pressure, but ultrasound does not penetrate metal. Common plastic allows ultrasonic to pass but will not withstand the high pressure in the well.

The inside of the housing 412 between the seal 424 and the transducer 416 should be filled with an ultrasonic amplification medium, e.g., water or oil. The device 400 needs to be powered by the battery 422, so the power budget is important. The practical limit is power supplied via a voltage of tens of volts given the size/volume constraints. Use of the ultrasonic amplification 425 medium permits weak ultrasonic waves to be detected.

As seen in FIG. 4C, the rotation and mirror can create a corkscrew emission pattern 428. With the present well sensor assembly 400, one ultrasonic transducer 416 is sufficient, which permits the device to be small and it can be installed into the wellbore with frac plug, and it is also low power. Effective rotation of the mirror emits ultrasound in all directions. More accurate images are provided as the rotation interval of the corkscrew pattern is reduced. A preferred rotation speed of the motor is about 1500 rpm. More generally, the faster the rotation speed, the clearer the image is that can be reconstructed from the data. Considering the run speed of the frac plug, at least 1000 rpm is preferable, and the faster it is, the better. Speeds about 1500 rpm can be used. The general limit on the speed of rotation is a function of the motor speed limit and power available for rotation.

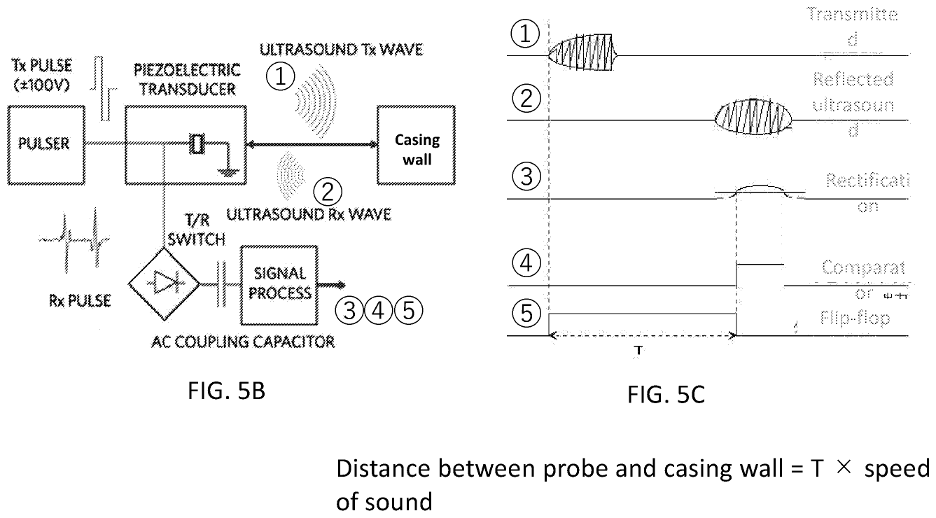

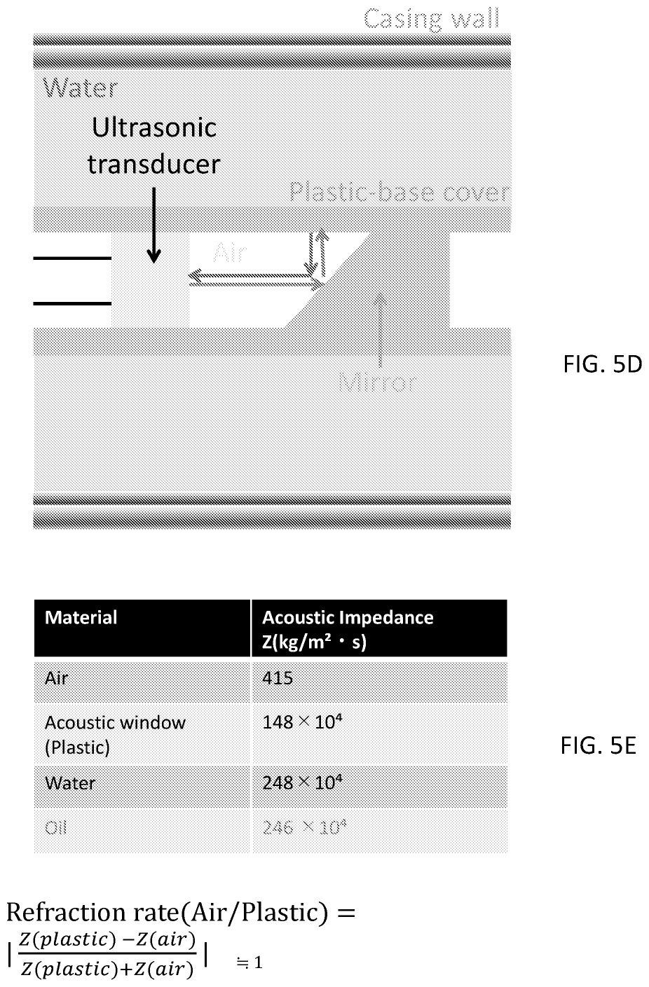

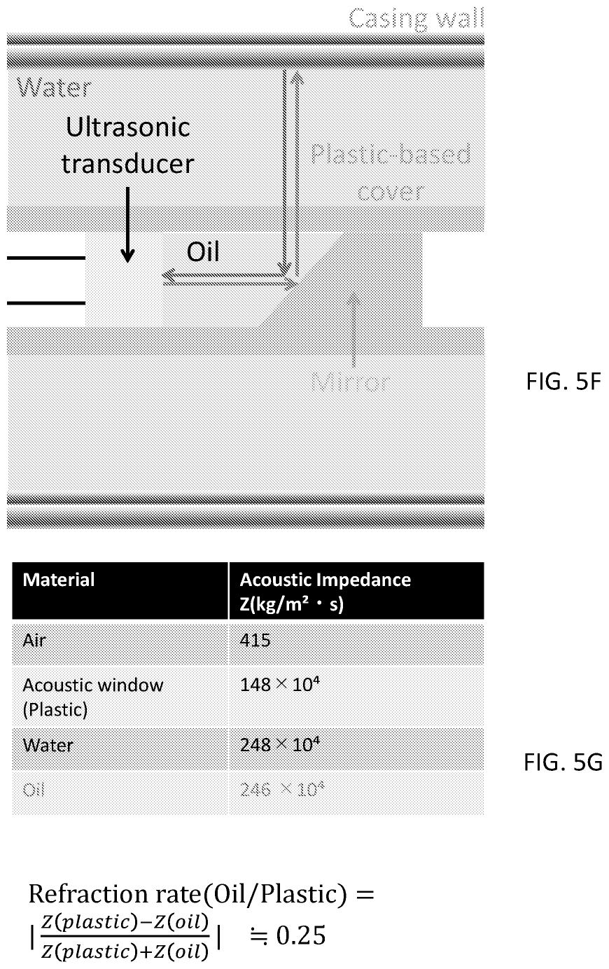

FIG. 5A shows a circuit for a preferred well sensor assembly 202 or 400, and FIGS. 5B-5F a method for imaging. The circuit is labelled with reference numbers from FIGS. 2A, 2B, 4A and 4B, with a temperature sensor 502 and memory 504 labelled separately from the microcontroller 214. In the method of FIGS. 5B-5G, the distance between the probe and the casing wall is calculated from the time from when the ultrasonic wave is emitted to when it is reflected by the casing wall and returned to the probe (traveling time). The signal is processed and converted into a digital signal so that the reflected wave can be detected reliably. In addition, a threshold is set so that noise can be removed. Finally, a flip-flop circuit is used to output the traveling time. The applicable signals are shown in FIG. 5C.

FIGS. 5D-5G show how material properties affecting imaging with the present well sensor assemblies. The differences in acoustic mediums of air and preferred acoustic amplification mediums of water and oils are shown and compared in FIGS. 5E and 5G. As noted above, the acoustic amplification medium permits low power imaging.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A well sensor system for downhole sensing, the system comprising:
a first housing dimensioned to attach to a downhole equipment piece while allowing the downhole equipment piece to perform its intended function;
a sensor within the first housing to sense one or more downhole conditions;
a controller with memory in the first housing to control sensor operation and sensor data collection; and
a first battery in the first housing to power the controller and sensors.

2. The well sensor system of claim 1, wherein the sensor comprises an imaging sensor having a second housing that is transparent to a sensing frequency of the imaging sensor and tolerant of downhole pressure to protect the imaging sensor and a second battery that powers the imaging sensor.

3. The well sensor system of claim 2, wherein the imaging sensor comprises an ultrasonic generator, an ultrasonic sensor, and a motor to rotate the ultrasonic generator.

4. The well sensor system of claim 3, comprising an ultrasonic amplification medium between the ultrasonic generator and the ultrasonic sensor.

5. The well sensor system of claim 4, wherein the ultrasonic generator comprises an angled mirror to direct emitted ultrasonic waves toward a wall of the housing and to direct reflected ultrasonic waves toward the ultrasonic generator.

6. The well sensor system of claim 5, wherein the ultrasonic generator is mounted on a mount that is driven by the motor, and wherein the mount extends through a seal that seals the ultrasonic amplification medium from the motor and the second battery that powers the motor.

7. The well sensor system of claim 6, wherein the second housing extends from a distal end of the first housing.

8. The well sensor system of claim 6, wherein the motor comprises an encoder.

9. The well sensor system of claim 1, wherein the first housing is dimensioned to fit through a central lumen of a frac plug and comprises a first attachment structure configured to attach to the frac plug.

10. The well sensor system of claim 9, wherein the first housing comprises a second attachment structure configured to attach to a setting tool.

11. The well sensor system of claim 2, wherein the second housing comprises a super engineered plastic or carbon fiber reinforced polymer (CRFP).

12. A well imaging sensor device, comprising:
a sealed housing transparent to ultrasound waves and resistant to downhole pressures, the housing being configured to attach to a downhole equipment piece while allowing the downhole equipment piece to perform its intended function, and, within the housing,
a battery, a motor, an ultrasound generator with an angled reflective surface, an ultrasound sensor spaced apart from the ultrasound generator, and ultrasonic amplification medium between the ultrasound generator and the ultrasound sensor, wherein the ultrasound generator is mounted on a mount that rotates in response to the motor and extends through a seal that seals the ultrasound amplification medium away from the battery and the motor.

13. The well imaging sensor device of claim 12, wherein the sealed housing comprises a super engineered plastic or carbon fiber reinforced polymer (CRFP).

14. The system of claim 12, wherein the ultrasonic amplification medium comprises water or oil.

15. The system of claim 14, wherein the ultrasonic amplification medium is oil.

16. The system of claim 12, wherein the motor and mount are configured to rotate the ultrasonic generator to create a corkscrew emission pattern.

17. A method for downhole imaging during use of another tool in a well, the method comprising
attaching a well imaging sensor to the another tool above ground;
inserting the another tool into the well;
imaging the well with the imaging sensor during the inserting;
collecting data from the well imaging sensor when the another tool returns above ground, wherein the well imaging sensor comprises a sealed housing transparent to ultrasound waves and resistant to downhole pressures, and within the housing, a single battery-powered ultrasonic generator and single battery-powered ultrasonic sensor, wherein the generator is configured to rotate and create a corkscrew emission pattern, and to reflect ultrasound reflections to the ultrasonic sensor.

18. The method of claim 17, further comprising monitoring rotation of the generator and controlling the rotation to set a desired rotation and corkscrew emission pattern.
